(19) United States
(12) Patent Application Publication
(10) Pub. No.: US 2026/0134805 A1
(43) Pub. Date: May 14, 2026

(54) METHODS FOR DETECTING FAILURE OF DISPLAY DEVICE AND ELECTRONIC DEVICE

(71) Applicant: Samsung Display Co., Ltd., Yongin-si (KR)

(72) Inventors: Dong Yeol YEOM, Yongin-si (KR); Hyun Ah SUH, Yongin-si (KR)

(21) Appl. No.: 19/359,389

(22) Filed: Oct. 15, 2025

(30) Foreign Application Priority Data
Nov. 13, 2024 (KR) 10-2024-0160836

(51) Int. Cl. G09G 3/00

(52) U.S. Cl. CPC G09G 3/006; G09G 2330/12; G09G 2360/16

(57) ABSTRACT

A method for detecting a failure of a display device including a display panel including a plurality of pixels, the method including: defining a first luminance waveform in a target area when halation does not occur; measuring, with a luminance measuring device facing a front of the display panel, a luminance in the target area while moving a pattern that is displayed on the display panel, and drawing a second luminance waveform based on the measured luminance; matching a starting point of the first luminance waveform and a starting point of the second luminance waveform with each other; and calculating a ratio of a difference in area between the first luminance waveform and the second luminance waveform.

### CROSS-REFERENCE TO RELATED APPLICATION

The present application claims priority to and the benefit of Korean Patent Application Number 10-2024-0160836, filed on November 13, 2024, in the Korean Intellectual Property Office, the entire disclosure of which is incorporated by reference herein.

### BACKGROUND

### 1. Field

Aspects of embodiments of the present disclosure relate to methods for detecting a failure of a display device and an electronic device.

### 2. Description of the Related Art

With the development of information technology, the importance of a display device, which is a connection medium between a user and information, has been emphasized. Due to the importance of display devices, the use of various kinds of display devices, such as a liquid crystal display device, an organic light-emitting display device, and a plasma display device, has increased.

In the liquid crystal display device, light is emitted from light sources in a backlight, and an image frame may be displayed by adjusting the amount of light transmitted from each pixel of a display panel.

The above information disclosed in this Background section is for enhancement of understanding of the background of the present disclosure, and therefore, it may contain information that does not constitute prior art.

### SUMMARY

Embodiments of the present disclosure may be directed to an efficient method for detecting a failure when a dynamic image is displayed.

According to one or more embodiments of the present disclosure, a method for detecting a failure of a display device including a display panel including a plurality of pixels, includes: defining a first luminance waveform in a target area when halation does not occur; measuring, with a luminance measuring device facing a front of the display panel, a luminance in the target area while moving a pattern that is displayed on the display panel, and drawing a second luminance waveform based on the measured luminance; matching a starting point of the first luminance waveform and a starting point of the second luminance waveform with each other; and calculating a ratio of a difference in area between the first luminance waveform and the second luminance waveform.

In an embodiment, the first luminance waveform may be defined by a speed of movement of the pattern, a width of the pattern in a direction of movement of the pattern, and a driving frequency of the display device.

In an embodiment, the first luminance waveform may have a pulse waveform having a width by dividing the width of the pattern by the speed of movement of the pattern, and then by the driving frequency of the display device.

In an embodiment, the pattern may have a shape of a rectangle.

In an embodiment, the target area may be located in a center of the display panel.

In an embodiment, in the measuring of the luminance in the target area while moving the pattern, the pattern may pass through the target area while moving from left of the target area to right of the target area.

In an embodiment, in the measuring of the luminance in the target area while moving the pattern, the pattern may pass through the target area while moving from above the target area to below the target area.

In an embodiment, the starting point of the second luminance waveform may correspond to a point prior to an adjacent point at which a reference value is measured among luminance values of the measured luminance.

In an embodiment, the reference value may correspond to twice a minimum value among the luminance values of the measured luminance.

In an embodiment, the ratio of the difference in area between the first luminance waveform and the second luminance waveform may be calculated by dividing an absolute value of a difference between an area of the first luminance waveform and an area of the second luminance waveform by the area of the first luminance waveform.

According to one or more embodiments of the present disclosure, a method for detecting a failure of a display device including a display panel including a plurality of pixels, includes: defining a first luminance waveform in a target area when halation does not occur; measuring, with the display panel tilted, a luminance in the target area while moving a pattern displayed on the display panel, and drawing a second luminance waveform based on the measured luminance; matching a starting point of the first luminance waveform and a starting point of the second luminance waveform with each other; and calculating a ratio of a difference in area between the first luminance waveform and the second luminance waveform.

In an embodiment, the first luminance waveform may be defined by a speed of movement of the pattern, a width of the pattern in a direction of movement of the pattern, and a driving frequency of the display device.

In an embodiment, the first luminance waveform may have a pulse waveform having a width by dividing the width of the pattern by the speed of movement of the pattern, and then by the driving frequency of the display device.

In an embodiment, the pattern may have a shape of a rectangle, and the target area may be located in a center of the display panel.

In an embodiment, in the measuring of the luminance in the target area while moving the pattern, the pattern may pass through the target area while moving from left of the target area to right of the target area.

In an embodiment, in the measuring of the luminance in the target area while moving the pattern, the pattern may pass through the target area while moving from above the target area to below the target area.

In an embodiment, the starting point of the second luminance waveform may correspond to a point prior to an adjacent point at which a reference value is measured among luminance values of the measured luminance.

In an embodiment, the reference value may correspond to twice a minimum value among the luminance values of the measured luminance.

In an embodiment, the ratio of the difference in area between the first luminance waveform and the second luminance waveform may be calculated by dividing an absolute value of a difference between an area of the first luminance waveform and an area of the second luminance waveform by the area of the first luminance waveform.

According to one or more embodiments of the present disclosure, a method for detecting a failure of an electronic device including a display panel including a plurality of pixels, includes: defining a first luminance waveform in a target area when halation does not occur; measuring, with a luminance measuring device facing a front of the display panel, a luminance in the target area while moving a pattern that is displayed on the display panel, and drawing a second luminance waveform based on the measured luminance; matching a starting point of the first luminance waveform and a starting point of the second luminance waveform with each other; and calculating a ratio of a difference in area between the first luminance waveform and the second luminance waveform.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a cross-sectional view of a display device according to an embodiment of the present disclosure.

FIG. 2 is a diagram illustrating a display panel according to an embodiment of the present disclosure.

FIG. 3 is a diagram illustrating a pixel according to an embodiment of the present disclosure.

FIG. 4 is a flowchart illustrating a method for detecting a failure of the display device of FIG. 1 according to an embodiment.

FIGS. 5A and 5B are diagrams illustrating a process of the method of FIG. 4.

FIGS. 6A and 6B are diagrams illustrating a process of the method of FIG. 4.

FIGS. 7A and 7B are diagrams illustrating a process of the method of FIG. 4.

FIG. 8 is a flowchart illustrating a method for detecting a failure of the display device of FIG. 1 according to another embodiment.

FIGS. 9A and 9B are diagrams illustrating a process of the method of FIG. 8.

FIGS. 10A-10C are diagrams illustrating a process of the method of FIG. 8.

FIG. 11 is a diagram illustrating a process of the method of FIG. 8.

FIG. 12 is a block diagram of an electronic device according to an embodiment.

FIGS. 13 to 15 shows schematic views of various embodiments of an electronic device.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being "electrically connected" to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” "includes," "including," "has," "have," and "having," when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression "A and/or B" denotes A, B, or A and B. Expressions such as “at least one of,” when preceding a list of elements, modify the entire list of elements and do not modify the individual elements of the list. For example, the expression "at least one of a, b, or c," “at least one of a, b, and c,” and “at least one selected from the group consisting of a, b, and c” indicates only a, only b, only c, both a and b, both a and c, both b and c, all of a, b, and c, or variations thereof.

As used herein, the term "substantially," "about," and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms "use," "using," and "used" may be considered synonymous with the terms "utilize," "utilizing," and "utilized," respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

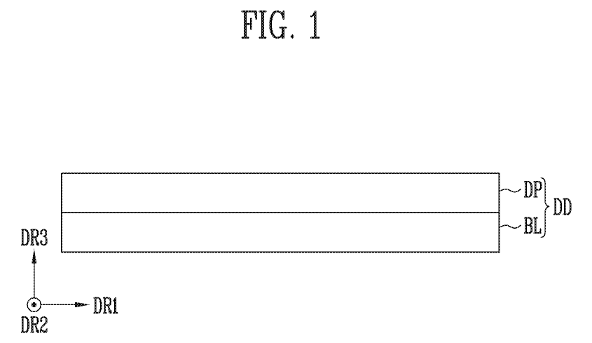

FIG. 1 is a cross-sectional view of a display device DD according to an embodiment of the present disclosure.

Referring to FIG. 1, the display device DD according to an embodiment of the present disclosure may include a display panel DP and a backlight BL. The display device DD may be implemented as any suitable kind of electronic device that displays images based on electrical signals. For example, the electronic device may include a smart phone, a tablet, a personal computer, a television, a billboard, an Internet of Things (IOT) device, and the like.

The display device DD may be a liquid crystal display device or another kind of light-transmissive display device. The display panel DP may be a liquid crystal display panel or another kind of light-transmissive display panel. A light-transmissive display panel may refer to a display panel in which at least some pixels of the display panel DP display images by adjusting the amount of light emitted from the backlight BL. For example, some of the pixels of the display panel DP may not use the backlight BL as a light source, and may include self-emitting devices.

The display panel DP may be positioned on the backlight BL. The display panel DP and the backlight BL may each be in the shape of a plate defining a plane extending in a first direction DR1 and a second direction DR2. In another embodiment, the display panel DP and the backlight BL may each be in the shape of a plate having a curved surface.

The display panel DP may be positioned in a third direction DR3 from the backlight BL. For convenience of illustration, the first direction DR1, the second direction DR2, and the third direction DR3 are assumed to be orthogonal to each other. In some embodiments of the present disclosure, unless otherwise specified, the first direction DR1 and the second direction DR2 may be used to indicate that a drawing is a plan view, and the second direction DR2 and the third direction DR3 may be used to indicate that a drawing is a cross-sectional view or a side view.

The first to third directions DR1 to DR3 are used to facilitate a description of a three-dimensional configuration of the display device DD, but the present disclosure is not limited thereto, and more directions may be defined and used in actual implemented products.

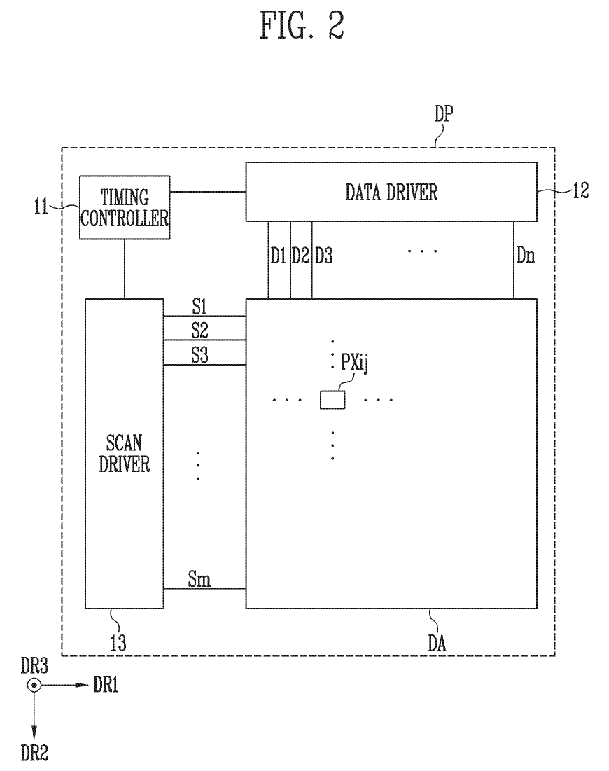

FIG. 2 is a diagram illustrating the display panel DP according to an embodiment of the present disclosure.

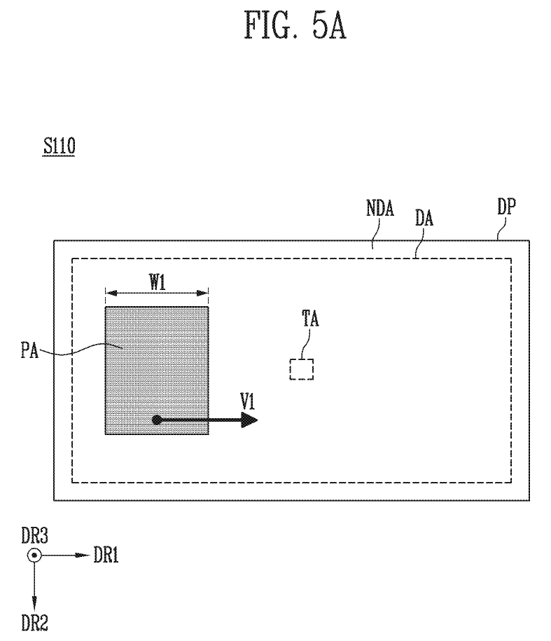

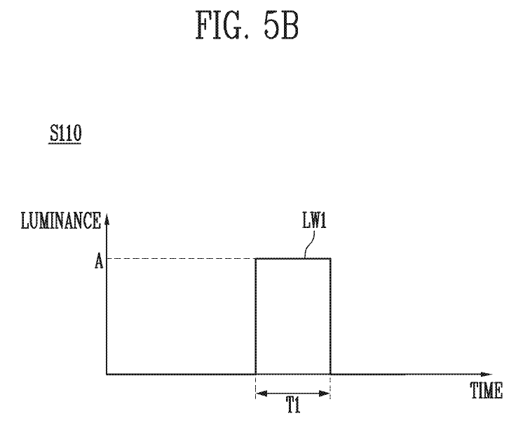

Referring to FIG. 2, the display panel DP according to an embodiment of the present disclosure may include a timing controller 11, a data driver 12, a scan driver 13, and a display area DA. In some embodiments, the timing controller 11, the data driver 12, and the scan driver 13 may be included in a non-display area NDA (e.g., see FIG. 5), but the present disclosure is not necessarily limited thereto.

The timing controller 11 may receive control signals and input grayscale values for an image frame from an external processor. The timing controller 11 may compensate for, adjust, or render the input grayscale values to generate output grayscale values. The timing controller 11 may supply the output grayscale values and the control signals to the data driver 12.

The data driver 12 may generate data voltages to be provided to data lines D1 to Dn by using the output grayscale values, the control signals, and the like, where n is an integer greater than 1. For example, data voltages generated on a pixel row basis (e.g., pixels connected to the same scan line as each other) may be applied to the data lines D1 to Dn concurrently (e.g., simultaneously or substantially simultaneously) with each other.

In addition, the timing controller 11 may generate a clock signal, a scan start signal, and the like to conform to a specification of the scan driver 13, and may supply the generated clock signal, scan start signal, and the like to the scan driver 13.

The scan driver 13 may receive the control signals, such as the clock signal and the scan start signal, from the timing controller 11 to generate scan signals to be provided to scan lines S1 to Sm, where m is an integer greater than 1. By providing the scan signals via the scan lines S1 to Sm, the scan driver 13 may select pixels to which the data voltages are to be written. For example, by sequentially providing turn-on level scan signals to the scan lines S1 to Sm, the scan driver 13 may select a pixel row to which the data voltages are to be written. Stage circuits of the scan driver 13 may be configured in the form of shift registers, and may generate the scan signals in a suitable manner of sequentially transmitting the scan start signal to a next stage circuit under the control of the clock signal.

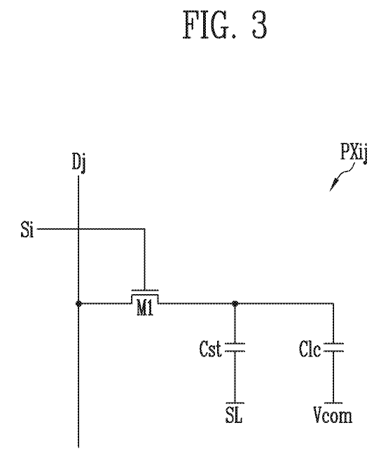

The display area DA includes the pixels. Each pixel may be connected to a corresponding data line and a corresponding scan line. For example, a pixel PXij located in an i-th pixel row (where i is an integer of 1 or more and m or less) and a j-th pixel column (where j is an integer of 1 or more and n or less) may be connected to an i-th scan line Si and a j-th data line Dj (e.g., see FIG. 3). When data voltages for one pixel row are applied to the data lines D1 to Dn from the data driver 12, the data voltages may be written to the one pixel row located on a scan line that receives a turn-on level scan signal from the scan driver 13.

FIG. 3 is a diagram illustrating a pixel according to an embodiment of the present disclosure.

Referring to FIG. 3, the pixel PXij located in the i-th pixel row and the j-th pixel column in the display panel DP may include a transistor M1, a storage capacitor Cst, and a liquid crystal capacitor Clc.

In the present embodiment, the transistor M1 is shown as an N-type transistor, and thus, a turn-on level of a scan signal may be a high level. However, the present disclosure is not limited thereto, and those having ordinary skill in the art may form a pixel circuit that performs the same or substantially the same function using a P-type transistor.

The transistor M1 may have a gate electrode connected to the i-th scan line Si, one electrode connected to the j-th data line Dj, and another electrode connected to one electrode of the storage capacitor Cst and a pixel electrode of the liquid crystal capacitor Clc.

The storage capacitor Cst may have the one electrode connected to the other electrode of the transistor M1, and another electrode connected to a sustain voltage line SL. However, the present disclosure is not limited thereto, and the storage capacitor Cst may be omitted when the liquid crystal capacitor Clc has a sufficient capacity.

The liquid crystal capacitor Clc may have the pixel electrode connected to the other electrode of the transistor M1, and a common electrode to which a common voltage Vcom may be applied. A liquid crystal layer may be located between the pixel electrode and the common electrode of the liquid crystal capacitor Clc. The common electrode may be shared by a plurality of pixels or all of the pixels of a pixel portion. The same common voltage may be applied to the plurality of pixels or all of the pixels through the common electrode.

When a turn-on level scan signal is supplied to the gate electrode of the transistor M1 through the i-th scan line Si, the transistor M1 connects the j-th data line Dj and the one electrode of the storage capacitor Cst to each other. Thus, the storage capacitor Cst stores a voltage corresponding to a difference between a data voltage applied through the j-th data line Dj and a sustain voltage of the sustain voltage line SL. The liquid crystal capacitor Clc maintains or substantially maintains the data voltage at the pixel electrode by the storage capacitor Cst. Therefore, an electric field corresponding to the difference between the data voltage and the common voltage is applied to the liquid crystal layer, and the orientation of liquid crystal molecules in the liquid crystal layer may be determined according to the electric field. A transmittance may correspond to the orientation of the liquid crystal molecules.

The display panel DP may further include a polarizing plate, a color filter, and the like as need or desired, as would be understood by those having ordinary skill in the art.

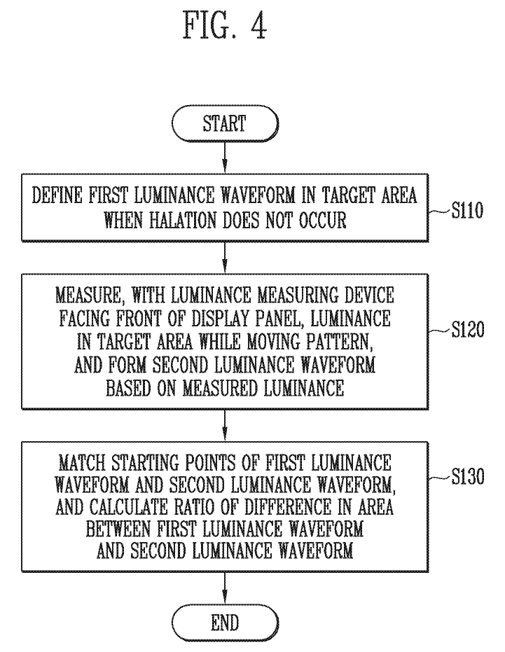

FIG. 4 is a flowchart illustrating a method for detecting a failure of the display device DD of FIG. 1 according to an embodiment.

Referring to FIGS. 1 and 4, the method may start, and a first luminance waveform in a target area on the display panel DP when halation does not occur may be defined (S110). The halation refers to a phenomenon of “light bleeding”, whereby, when an image with a clear contrast between light and darkness is displayed on the display panel DP, a boundary of a dark area appears white and bleeds.

The process S110 will be described in more detail below with reference to FIGS. 5A and 5B.

A luminance measuring device facing the front of the display panel DP may measure the luminance in the target area while moving a pattern displayed on the display panel DP, and a second luminance waveform may be formed (e.g., drawn) based on the measured luminance (S120).

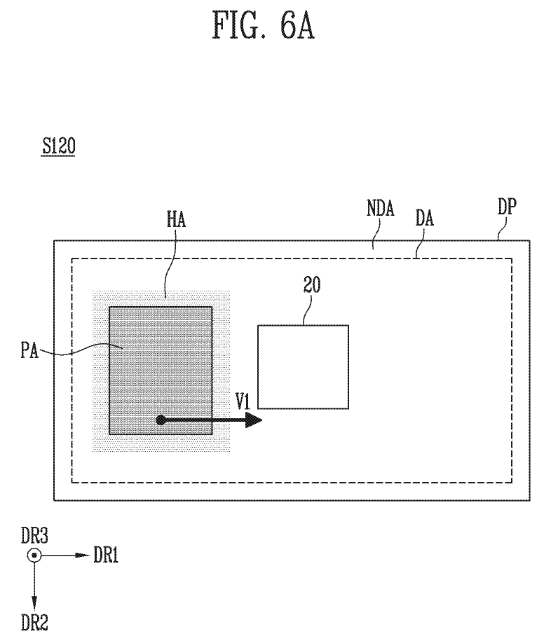

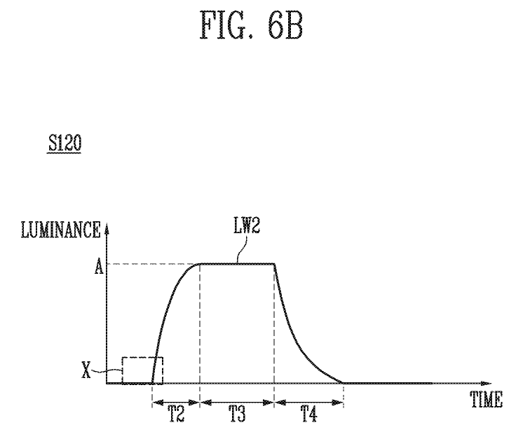

The process S120 will be described in more detail below with reference to FIGS. 6A and 6B.

A starting point of the first luminance waveform and a starting point of the second luminance waveform may be matched, and a ratio of a difference in area between the first luminance waveform and the second luminance waveform may be calculated (S130).

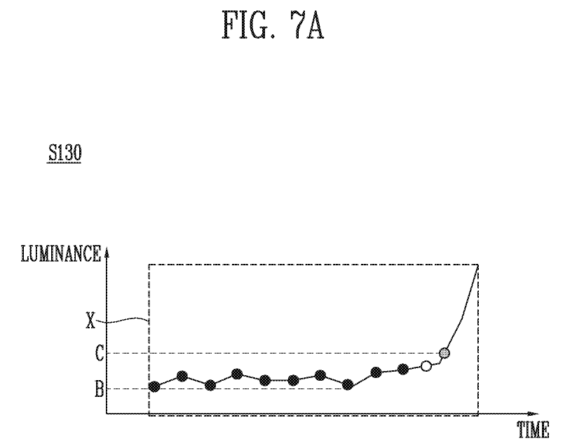

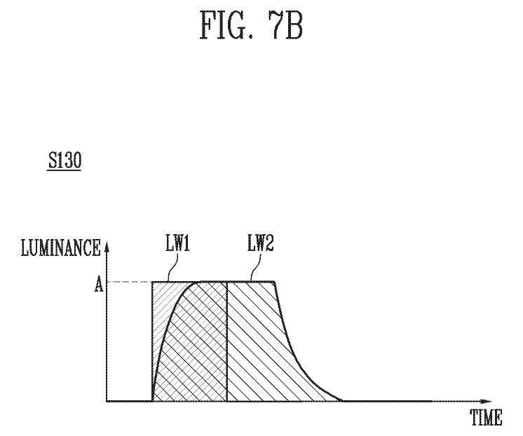

The process S130 will be described in more detail below with reference to FIGS. 7A and 7B.

FIGS. 5A and 5B are diagrams illustrating the process S110 of the method of FIG. 4.

Referring to FIGS. 2, 4, and 5A, the display panel DP may include the display area DA and the non-display area NDA. The display area DA may be an area in which an image is displayed by the pixels. A pattern PA may be an image displayed by the pixels in the display area DA.

The pattern PA may be a dynamic image. For example, the pattern PA may move at a first velocity V1 in the first direction DR1, and may pass through a target area TA.

The pattern PA may move from an area to the left of the target area TA to an area to the right of the target area TA, but the movement of the pattern PA is not limited thereto. In a method for detecting a failure according to an embodiment, the pattern PA may move from above the target area TA to below the target area TA. In a method for detecting a failure according to an embodiment, the pattern PA may move from an area to the upper left side of the target area TA to an area to the lower right side of the target area TA. As described above, the pattern PA may traverse the target area TA in various suitable paths.

The pattern PA may have a variety of suitable shapes. For example, the pattern PA may have a rectangle shape having a width equal to a first length W1 in the first direction DR1 as shown in FIG. 5A.

Grayscales of the pattern PA and an area except for the pattern PA may have various suitable combinations. For example, the grayscale of the pattern PA may be higher than the grayscale of the area except for the pattern PA. For example, the grayscale of the pattern PA may be lower than the grayscale of the area except for the pattern PA.

The target area TA may be an area of which a luminance is measured by a luminance measuring device 20 (e.g., see FIG. 6A). In a method for detecting a failure according to an embodiment, the target area TA may be located in the center of the display area DA, but the present disclosure is not limited thereto. For example, the target area TA may be located at an edge of the display area DA.

Hereinafter, with reference to FIGS. 5B to 7B, for convenience of illustration, the target area TA may be an area located in the center of the display area DA, and the pattern PA, which may be a rectangle having the width equal to the first length W1 in the first direction DR1, may move at the first velocity V1 from the left of the target area TA to the right of the target area TA. In addition, for convenience of illustration, the pattern PA may emit light of a higher luminance than that of the area except for the pattern PA. However, the present disclosure is not limited thereto.

Referring to FIG. 5B, a first luminance waveform LW1 defined when halation does not occur (e.g., in the case of normal driving) is shown. Values on the horizontal axis represent time, and values on the vertical axis represent the luminance predicted to be measured by the luminance measuring device 20 (e.g., see FIG. 6A).

The first luminance waveform LW1 is not drawn based on the luminance measured by the luminance measuring device 20. The first luminance waveform LW1 may be defined by a speed of the movement of the pattern PA, the width of the pattern PA in the direction of movement of the pattern PA, and a driving frequency of the display device DD (or the display panel DP). In other words, the first luminance waveform LW1 may be an imaginary waveform that is drawn based on a prediction of the luminance that would be measured by the luminance measuring device 20 when halation does not occur (e.g., in the case of normal driving).

The first luminance waveform LW1 may be in the form of a pulse. For example, the first luminance waveform LW1 may be in the form of a square pulse.

A first period T1 in the first luminance waveform LW1 may correspond to a period when the pattern PA passes through the target area TA. The first period T1 of the first luminance waveform LW1 may correspond to a time period during which the luminance measuring device 20 measures the luminance of the pattern PA. Thus, in the first period T1 of the first luminance waveform LW1, the luminance may be defined as having a luminance value of A (where A is an integer greater than or equal to 0) by the pattern PA. On the other hand, time periods other than the first period T1 of the first luminance waveform LW1 may correspond to time periods during which the luminance measuring device 20 measures a luminance of the area except for the pattern PA. Accordingly, the time periods other than the first period T1 of the first luminance waveform LW1 may be defined as having a luminance value other than A.

The length of the first period T1 may be calculated by dividing the width of the pattern PA in the direction of the movement of the pattern PA by the speed of the movement of the pattern PA, and then by the driving frequency of the display device DD (or the display panel DP). For example, in FIG. 5A, the pattern PA moves in the first direction DR1, the width of the pattern PA in the first direction DR1 is the first length W1, and the speed of the movement of the pattern PA is the first velocity V1. Therefore, the length of the first period T1 may be calculated by dividing the first length W1 by the first velocity V1, and then by the driving frequency of the display device DD (or the display panel DP).

In a state where the speed of the movement of the pattern PA and the driving frequency of the display device DD are constant or substantially constant, the length of the first period T1 may increase as the width of the pattern PA in the direction of the movement of the pattern PA increases.

FIGS. 6A and 6B are diagrams illustrating the process S120 of the method of FIG. 4.

Referring to FIG. 6A, in a method for detecting a failure of the display device DD according to an embodiment, one surface of the display panel DP may face the third direction DR3 while the display panel DP is not tilted. The luminance measuring device 20 (e.g., a luminance sensor, an image sensor, a camera, and/or the like) may be arranged to face the target area TA of the display panel DP in the third direction DR3 of the display panel DP. The luminance measuring device 20 may measure the luminance on the target area TA while the luminance measuring device 20 is fixed.

When halation occurs in the display panel DP (e.g., when the display panel DP is driven abnormally), a halation area HA may be formed around the pattern PA. The halation area HA may correspond to an area where a boundary of the pattern PA appears white and bleeds.

When any halation does not occur in the display panel DP, the luminance measured by the luminance measuring device 20 changes when the pattern PA begins to pass through the target area TA, and the luminance measured by the luminance measuring device 20 changes when the pattern PA leaves the target area TA. Accordingly, a luminance waveform based on the luminance measured by the luminance measuring device 20 may be the same or substantially the same as the first luminance waveform LW1 illustrated in FIG. 5B.

However, when the halation occurs in the display panel DP, the luminance measured by the luminance measuring device 20 may begin to change as the halation area HA begins to pass through the target area TA. In addition, when the halation occurs in the display panel DP, even when the pattern PA leaves the target area TA, the luminance measured by the luminance measuring device 20 may change until the halation area HA leaves the target area TA.

In other words, when the halation occurs in the display panel DP, a luminance waveform based on the luminance measured by the luminance measuring device 20 may be different from the first luminance waveform LW1 illustrated in FIG. 5B.

FIG. 6B illustrates a second luminance waveform LW2 drawn based on the luminance measured in a case where halation occurs in the display panel DP (e.g., in the case of abnormal driving). Values on the horizontal axis represent time, and values on the vertical axis represent the luminance measured by the luminance measuring device 20 (e.g., see FIG. 6A).

The second luminance waveform LW2 may include second to fourth periods T2, T3, and T4. The second period T2 may correspond to a period in which the luminance measured by the luminance measuring device 20 changes due to the halation area HA as the pattern PA approaches the target area TA. The third period T3 may correspond to a period in which the luminance of the pattern PA is measured as the pattern PA passes through the target area TA. The fourth period T4 may correspond to a period in which the luminance measured by the luminance measuring device 20 changes due to the halation area HA after the pattern PA passes through the target area TA.

The halation area HA may be the area where light bleeding occurs at the boundary of the pattern PA, and a portion of the halation area HA may have a higher luminance in the direction toward the pattern PA. On the other hand, a portion of the halation area HA may have a lower luminance in the direction away from the pattern PA.

In the second period T2, the measured luminance may increase over time until the measured luminance reaches the luminance value of A. In the third period T3, the constant or substantially luminance having the luminance value of A may be measured. In the fourth period T4, the luminance may decrease over time.

As illustrated in FIG. 6B, the second luminance waveform LW2 drawn based on the luminance measured by the luminance measuring device 20 when the halation occurs in the display panel DP may be different from the first luminance waveform LW1 illustrated in FIG. 5B.

FIGS. 7A and 7B are diagrams illustrating the process S130 of the method of FIG. 4. FIG. 7A is an enlarged view of the part X of FIG. 6B. Before calculating the ratio of the difference in area between the second luminance waveform LW2 and the first luminance waveform LW1, a starting point of the second luminance waveform LW2 and a starting point of the first luminance waveform LW1 may be matched with each other. FIG. 7A is a diagram illustrating a criterion for defining the starting point of the second luminance waveform LW2.

Referring to FIG. 7A, each of a plurality of dots represents the luminance of the target area TA measured by the luminance measuring device 20. The second luminance waveform LW2 is drawn by connecting the plurality of dots.

A minimum luminance value may be a luminance value of B among luminance values of the luminance measured by the luminance measuring device 20. Over time, as the pattern PA approaches the target area TA, the luminance measured by the luminance measuring device 20 increases. The starting point of the second luminance waveform LW2 may correspond to a point immediately prior to a point at which a reference value is measured among the luminance values of the luminance measured by the luminance measuring device 20.

The reference value may be variously defined. For example, the reference value may be a value that is twice the minimum value among the luminance values of the luminance measured by the luminance measuring device 20. When the reference value is defined as described above, and a luminance value C is twice the luminance value of B in FIG. 7A, the starting point of the second luminance waveform LW2 may correspond to a point immediately prior to a point at which the luminance having the luminance value of C is measured.

FIG. 7B shows the first luminance waveform LW1 defined based on luminance values that are predicted to be measured in a case where the halation does not occur in the display panel DP. FIG. 7B also shows the second luminance waveform LW2 drawn based on the luminance values that are actually measured by the luminance measuring device 20.

The starting point of the first luminance waveform LW1 may correspond to a point at which the luminance changes sharply in the pulse waveform. The starting point of the second luminance waveform LW2 may correspond to the point immediately prior to the point at which the reference value is measured among the luminance values of the luminance measured by the luminance measuring device 20 as described above with reference to FIG. 7A.

FIG. 7B shows a state in which the starting point of the first luminance waveform LW1 and the starting point of the second luminance waveform LW2 are matched with each other.

The ratio of the difference in area between the first luminance waveform LW1 and the second luminance waveform LW2 may be calculated as described in more detail below.

First, the area of the first luminance waveform LW1 may be calculated. In more detail, the area defined by the first luminance waveform LW1 and the horizontal axis may be calculated (e.g., see the hatched area with diagonal lines drawn from bottom left to top right).

Then, the area of the second luminance waveform LW2 may be calculated. In more detail, the area defined by the second luminance waveform LW2 and the horizontal axis may be calculated (e.g., see the hatched area with diagonal lines drawn from top left to bottom right).

A ratio of the difference in area may be calculated by dividing the absolute value of the difference between the area of the first luminance waveform LW1 and the area of the second luminance waveform LW2 by the area of the first luminance waveform LW1.

The greater the ratio of the difference in area when calculated as above, the greater the difference between the first luminance waveform LW1 and the second luminance waveform LW2, and the greater the degree of an occurrence of the halation when the pattern PA moves. In addition, the greater the degree of the occurrence of the halation, the greater the failure in the display panel DP.

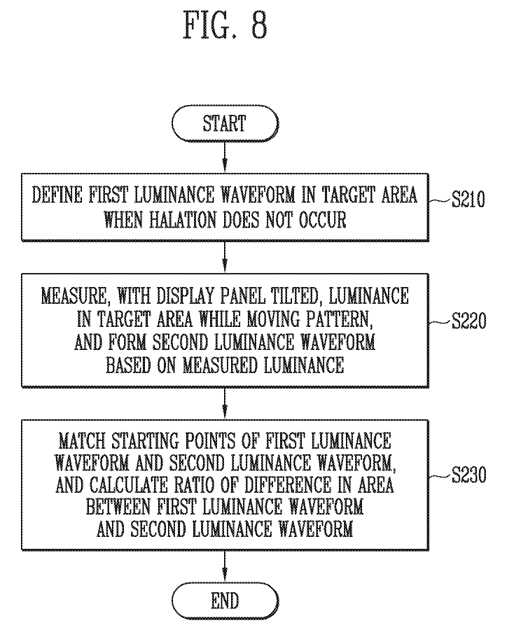

FIG. 8 is a flowchart illustrating a method for detecting a failure of the display device DD of FIG. 1 according to another embodiment.

Referring to FIGS. 1 and 8, the method may start, and the first luminance waveform in the target area on the display panel DP when halation does not occur may be defined (S210). The halation may refer to a phenomenon of “light bleeding”, whereby, when an image with a clear contrast between light and darkness is displayed on the display panel DP, a boundary of a dark area appears white and bleeds.

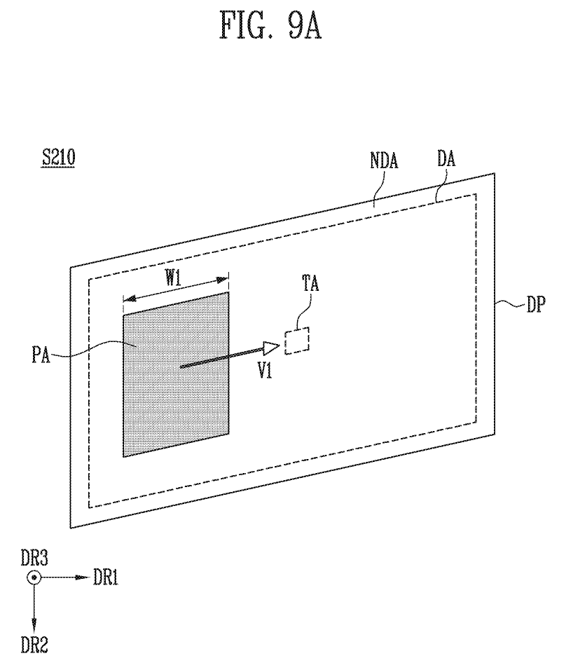

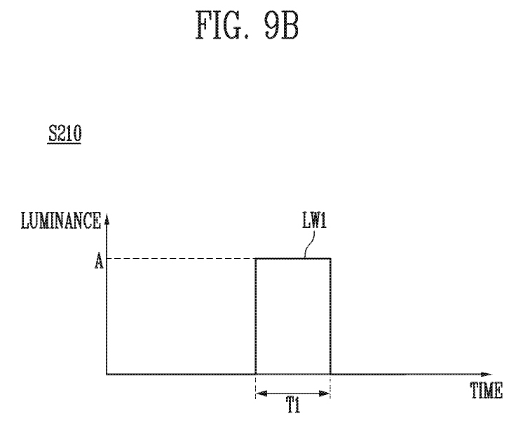

The process S210 will be described in more detail below with reference to FIGS. 9A and 9B.

With the display panel DP tilted, the luminance at the target area may be measured while moving the pattern displayed on the tilted display panel DP, and the second luminance waveform may be formed (e.g., drawn) based on the measured luminance (S220).

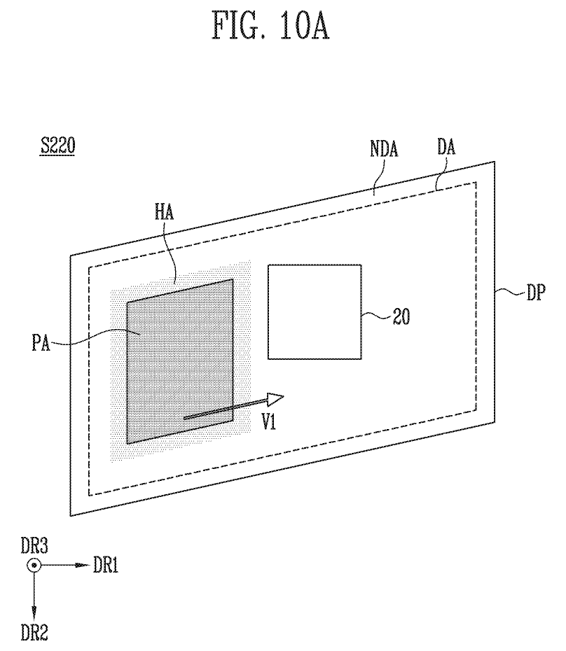

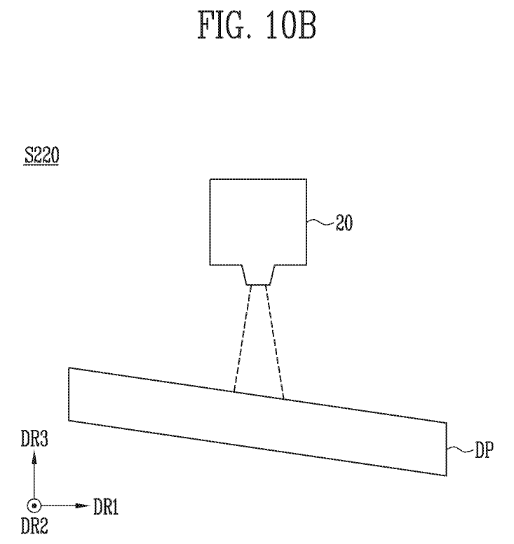

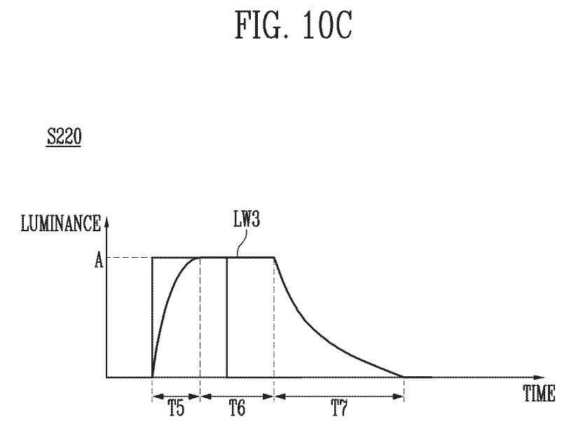

The process S220 will be described in more detail below with reference to FIGS. 10A to 10C.

The starting point of the first luminance waveform and the starting point of the second luminance waveform may be matched with each other, and a ratio of the difference in area between the first luminance waveform and the second luminance waveform may be calculated (S230), such that the method may end.

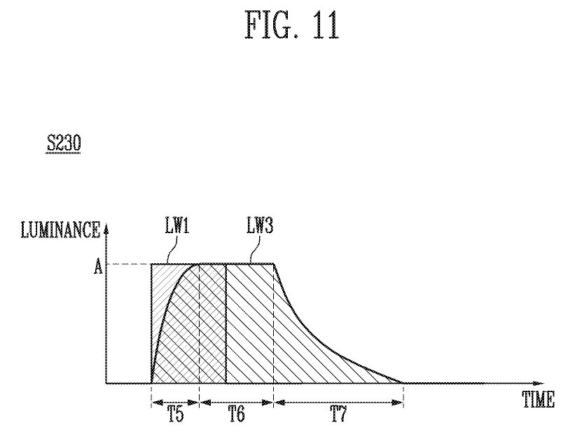

The process S230 will be described in more detail below with reference to FIG. 11.

FIGS. 9A and 9B are diagrams illustrating the process S210 of the method of FIG. 8.

Referring to FIGS. 2, 8, and 9A, the display panel DP may be tilted. For example, in FIG. 9A and following figures, the display panel DP may be tilted from the third direction DR3 toward the first direction DR1.

The display panel DP may include the display area DA and the non-display area NDA. The display area DA may be an area in which an image is displayed by the pixels. The pattern PA may be an image displayed by the pixels in the display area DA.

The pattern PA may be a dynamic image. For example, the pattern PA may move at the first velocity V1, and pass through the target area TA.

The pattern PA may move from an area to the left of the target area TA to an area to the right of the target area TA, but the movement of the pattern PA is not limited thereto. In a method for detecting a failure according to another embodiment, the pattern PA may move from above the target area TA to below the target area TA. In a method for detecting a failure according to another embodiment, the pattern PA may move from an area to the upper left side of the target area TA to an area to the lower right side of the target area TA. As described above, the pattern PA may traverse the target area TA in various suitable paths.

The pattern PA may have a variety of suitable shapes. For example, the pattern PA may be a rectangle having a width equal to the first length W1 in the direction of the movement of the pattern PA, as shown in FIG. 9A.

The grayscales of the pattern PA and the area except for the pattern PA may have various suitable combinations. For example, the grayscale of the pattern PA may be higher than the grayscale of the area except for the pattern PA. For example, the grayscale of the pattern PA may be lower than the grayscale of the area except for the pattern PA.

The target area TA may be an area of which the luminance is measured by the luminance measuring device 20 (e.g., see FIG. 6A). In a method for detecting a failure according to another embodiment, the target area TA may be located in the center of the display area DA, but the present disclosure is not limited thereto. For example, the target area TA may be located at an edge of the display area DA.

Hereinafter, with reference to FIGS. 9B to 11, for convenience of illustration, the target area TA may be an area located in the center of the display area DA, and the pattern PA, which may be a rectangle having the width equal to the first length W1 in the direction of the movement of the pattern PA, may move at the first velocity V1 from the left of the target area TA to the right of the target area TA in the direction of movement of the pattern PA. In addition, the pattern PA may emit light of a higher luminance than that of the area except for the pattern PA. However, the present disclosure is not limited thereto

Referring to FIG. 9B, the first luminance waveform LW1 defined when halation does not occur (e.g., in the case of normal driving) is shown. Values on the horizontal axis represent time, and values on the vertical axis represent the luminance that is predicted to be measured by the luminance measuring device 20 (e.g., see FIG. 6A).

The first luminance waveform LW1 is not drawn based on the luminance that is measured by the luminance measuring device 20. The first luminance waveform LW1 may be defined by a speed of the movement of the pattern PA, the width of the pattern PA in the direction of the movement of the pattern PA, and the driving frequency of the display device DD (or the display panel DP). In other words, the first luminance waveform LW1 may be an imaginary waveform that is drawn based on a prediction of the luminance that would be measured by the luminance measuring device 20 when halation does not occur (e.g., in the case of normal driving).

The first luminance waveform LW1 may be in the form of a pulse. For example, the first luminance waveform LW1 may be in the form of a square pulse.

The first period T1 in the first luminance waveform LW1 may correspond to a period when the pattern PA passes through the target area TA. The first period T1 of the first luminance waveform LW1 may correspond to a time period during which the luminance measuring device 20 measures the luminance of the pattern PA. Thus, in the first period T1 of the first luminance waveform LW1, the luminance may be defined as having the luminance value of A (where A is an integer greater than or equal to 0) by the pattern PA. On the other hand, the time periods other than the first period T1 of the first luminance waveform LW1 may correspond to time periods during which the luminance measuring device 20 measures the luminance of the area except for the pattern PA. Thus, the time periods other than the first period T1 of the first luminance waveform LW1 may be defined as having the luminance value other than A.

The length of the first period T1 may be calculated by dividing the width of the pattern PA in the direction of the movement of the pattern PA by the speed of movement of the pattern PA, and then by the driving frequency of the display device DD (or the display panel DP). For example, in FIG. 9A, the width of the pattern PA in the direction of the movement of the pattern PA is the first length W1, and the speed of the movement of the pattern PA is the first velocity V1. Therefore, the length of the first period T1 may be calculated by dividing the first length W1 by the first velocity V1, and then by the driving frequency of the display device DD (or the display panel DP).

FIGS. 10A through 10C are diagrams illustrating the process S220 of FIG. 8.

Referring to FIG. 10A, in a method for detecting a failure of the display device DD according to an embodiment, the display panel DP may be tilted. For example, a normal line on one surface of the display panel DP may be tilted from the first direction DR1 toward the third direction DR3.

However, the present disclosure is not limited thereto, and the tilted direction and the degree of tilt of the display panel DP are not limited to those illustrated in FIG. 10A. For convenience of illustration, hereinafter, the normal line on one surface of the display panel DP may be tilted from the first direction DR1 toward the third direction DR3.

Referring to FIG. 10B, a different angle of a view of the display panel DP and the luminance measuring device 20 (e.g., a luminance sensor, an image sensor, a camera, and/or the like) is illustrated to provide a more detailed view of the arrangement of the display panel DP and the luminance measuring device 20.

The luminance measuring device 20 may measure the luminance on the target area TA while the luminance measuring device 20 is fixed. Because the display panel DP is tilted, the luminance measuring device 20 may measure the luminance on the target area TA while facing the target area TA obliquely.

When halation occurs in the display panel DP (e.g., when the display panel DP is driven abnormally), the halation area HA may be formed around the pattern PA. The halation area HA may correspond to an area where the boundary of the pattern PA appears white and bleeds.

When any halation does not occur in the display panel DP, the luminance measured by the luminance measuring device 20 changes when the pattern PA begins to pass through the target area TA, and the luminance measured by the luminance measuring device 20 changes when the pattern PA leaves the target area TA. Accordingly, a luminance waveform based on the luminance measured by the luminance measuring device 20 may be the same or substantially the same as the first luminance waveform LW1 illustrated in FIG. 9B.

However, when the halation occurs in the display panel DP, the luminance measured by the luminance measuring device 20 begins to change as the halation area HA begins to pass through the target area TA. In addition, when the halation occurs in the display panel DP, even when the pattern PA leaves the target area TA, the luminance measured by the luminance measuring device 20 changes until the halation area HA leaves the target area TA.

In other words, when the halation occurs in the display panel DP, the luminance waveform based on the luminance measured by the luminance measuring device 20 may be different from the first luminance waveform LW1 illustrated in FIG. 9B.

Referring to FIG. 10B, one surface of the display panel DP may not face the luminance measuring device 20 directly, but may be tilted. Accordingly, the luminance measuring device 20 may measure the luminance of the target area TA on the display panel DP while facing the target area TA obliquely.

FIG. 10C illustrates a third luminance waveform LW3 drawn based on the luminance measured in a case where halation occurs in the display panel DP (e.g., in the case of abnormal driving). Values on the horizontal axis represent time, and values on the vertical axis represent the luminance measured by the luminance measuring device 20 (e.g., see FIG. 10A).

The third luminance waveform LW3 may include fifth to seventh periods T5, T6, and T7. The fifth period T5 may correspond to a period in which the luminance measured by the luminance measuring device 20 changes due to the halation area HA as the pattern PA approaches the target area TA. The sixth period T6 may correspond to a period in which the luminance of the pattern PA is measured as the pattern PA passes through the target area TA. The seventh period T7 may correspond to a period in which the luminance measured by the luminance measuring device 20 changes due to the halation area HA after the pattern PA passes through the target area TA.

The halation area HA may be an area where light bleeding occurs at the boundary of the pattern PA, and a portion of the halation area HA may have a higher luminance in the direction toward the pattern PA. On the other hand, a portion of the halation area HA may have a lower luminance in the direction away from the pattern PA.

In the fifth period T5, the measured luminance may increase over time until the measured luminance reaches the luminance value of A. In the sixth period T6, a constant or substantially constant luminance having the luminance value of A may be measured. In the seventh period T7, the luminance may decrease over time.

As shown in FIG. 10C, the third luminance waveform LW3 drawn based on the luminance measured by the luminance measuring device 20 when the halation occurs in the display panel DP may be different from the first luminance waveform LW1 illustrated in FIG. 9B.

FIG. 11 is a diagram illustrating the process S230 of the method of FIG. 8.

FIG. 11 shows the first luminance waveform LW1 defined based on luminance values that are predicted to be measured in a case where the halation does not occur in the display panel DP. FIG. 11 also shows the third luminance waveform LW3 drawn based on the luminance values that are actually measured by the luminance measuring device 20.

A starting point of the first luminance waveform LW1 may correspond to a point at which the luminance changes sharply in the pulse waveform. A starting point of the third luminance waveform LW3 may correspond to a point immediately prior to the point at which a reference value is measured among the luminance values of the luminance measured by the luminance measuring device 20, as described above with reference to FIG. 7A.

FIG. 11 shows a state in which the starting point of the first luminance waveform LW1 and the starting point of the third luminance waveform LW3 are matched with each other.

A ratio of the difference in area between the first luminance waveform LW1 and the third luminance waveform LW3 may be calculated as described in more detail below.

First, the area of the first luminance waveform LW1 may be calculated. In more detail, the area defined by the first luminance waveform LW1 and the horizontal axis may be calculated (e.g., see the hatched area with diagonal lines drawn from bottom left to top right).

Then, the area of the third luminance waveform LW3 may be calculated. In more detail, the area defined by the third luminance waveform LW3 and the horizontal axis may be calculated (e.g., see the hatched area with diagonal lines drawn from top left to bottom right).

A ratio of the difference in area may be calculated by dividing the absolute value of the difference between the area of the first luminance waveform LW1 and the area of the third luminance waveform LW3 by the area of the third luminance waveform LW3.

The greater the ratio of the difference in area calculated as described above, the greater the difference between the first luminance waveform LW1 and the third luminance waveform LW3, and the greater the degree of an occurrence of the halation when the pattern PA moves. In addition, the greater the degree of an occurrence of the halation, the greater the failure in the display panel DP.

According to some embodiments of the present disclosure as described above, the luminance measuring device 20 (e.g., a luminance sensor, an image sensor, a camera, and/or the like) may be connected to or may further include a processing circuit for performing at least some of the processes of the methods described above. The processing circuit and/or any other relevant devices or components according to embodiments of the present disclosure described above may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities and processes described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality and the processes of various computing devices may be combined or integrated into a single computing device, or the functionality of a particular computing device may be distributed across one or more other computing devices without departing from the spirit and scope of the example embodiments of the present disclosure.

According to some embodiments of the present disclosure, an efficient method for detecting a failure when a dynamic image is displayed may be provided. However, the present disclosure is not limited to the above aspects and features.

A display device according to an embodiment is applicable to various types of electronic devices. In an embodiment, an electronic device includes the above-described display device and may further include other modules or devices with additional functions in addition to the display device.

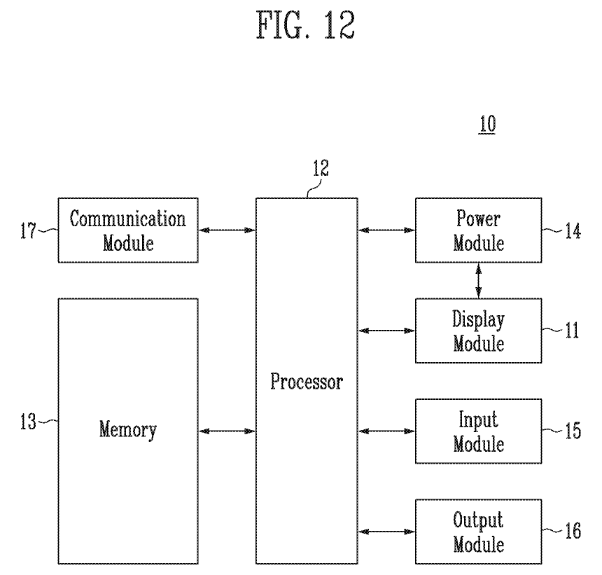

FIG. 12 is a block diagram of an electronic device according to an embodiment. Referring to FIG. 12, the electronic device 10 may include a display module 11, a processor 12, a memory 13, and a power module 14. The electronic device 10 may further include an input module 15, a non-image output module 16, and/or a communication module 17.

The electronic device 10 may output various types of information in the form of an image through the display module 11. When the processor 12 executes an application stored in the memory 13, the application may display image information to a user through the display module 11. The power module 14 may include a power supply module, such as a power adapter or a battery device, and a power conversion module. The power conversion module converts power supplied by the power supply module and generates power to operate the electronic device 10. The input module 15 may provide input information to the processor 12 and/or the display module 11. The non-image output module 16 may receive information other than image information from the processor 12, such as information as to sound, haptic feedback, and light emission, and provide the information to the user. The communication module 16 may serve to facilitate information exchange between the electronic device 10 and an external device, and may include a transmitter and a receiver.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

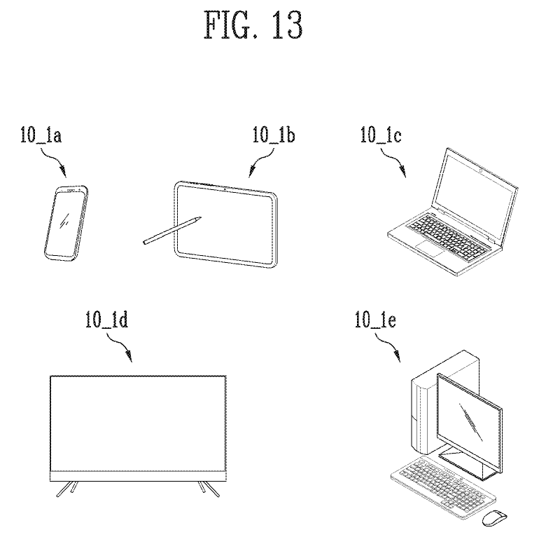

FIGS. 13 to 15 shows schematic views of various embodiments of an electronic device. FIGS. 13 to 15 illustrate examples of various types of electronic devices to which embodiments of a display device are applied.

FIG. 13 shows a smartphone 10_1a, a tablet PC 10_1b, a laptop computer 10_1c, a television (TV) 10_1d, and a desktop monitor 10_1e as examples of the electronic device 10.

The smartphone 10_1a may include an input module, such as a touch sensor, and a communication module in addition to the display module 11. The smartphone 10_1a may process information received through the communication module or the input module and display the processed information on the display module of the display device.

Similarly to the smartphone 10_1a, the tablet PC 10_1b, the laptop computer 10_1c, the television (TV) 10_1d, and the desktop monitor 10_1e may each include a display module and an input module and further include a communication module in some embodiments.

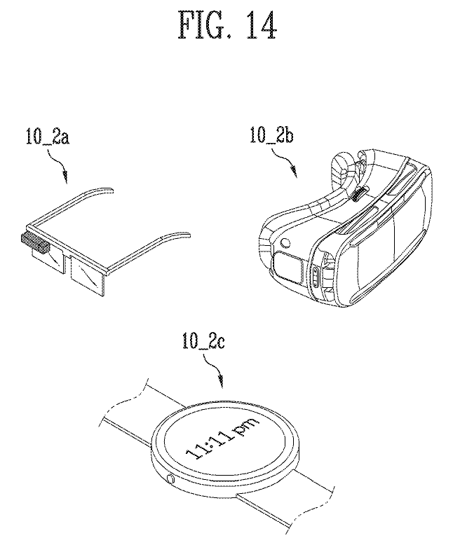

FIG. 14 shows examples in which the electronic device 10 including the display module 11 is applied to a wearable electronic device. The examples of the wearable electronic device may include smart glasses 10_2a, a head-mounted display (HMD) 10_2b, and a smart watch 10_2c.

The smart glasses 10_2a and the head-mounted display 10_2b may each include a display module that projects a display image and a reflector that reflects the projected display image to direct it to the user’s eyes, thereby providing the user with a virtual reality or augmented reality screen.

The smart watch 10_2c may include a biometric sensor as an input device and provide biometric information detected by the biometric sensor to the user through a display module.

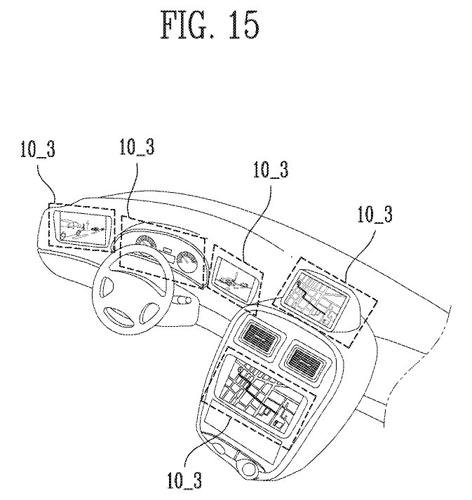

FIG. 15 shows an example in which the electronic device 10 including the display module 11 is applied to various kinds of an automotive electronic device 10_3. For example, the automotive electronic device 10_3 is applied to a center information display (CID), which may be employed in the instrument cluster or the center fascia of the vehicle or disposed at the dashboard of the vehicle. The automotive electronic device 10_3 may also be applied to a room mirror display replacing side mirrors.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A method for detecting a failure of a display device comprising a display panel comprising a plurality of pixels, the method comprising:
defining a first luminance waveform in a target area when halation does not occur;
measuring, with a luminance measuring device facing a front of the display panel, a luminance in the target area while moving a pattern that is displayed on the display panel, and drawing a second luminance waveform based on the measured luminance;
matching a starting point of the first luminance waveform and a starting point of the second luminance waveform with each other; and
calculating a ratio of a difference in area between the first luminance waveform and the second luminance waveform.

2. The method according to claim 1, wherein the first luminance waveform is defined by a speed of movement of the pattern, a width of the pattern in a direction of movement of the pattern, and a driving frequency of the display device.

3. The method according to claim 2, wherein the first luminance waveform has a pulse waveform having a width by dividing the width of the pattern by the speed of movement of the pattern, and then by the driving frequency of the display device.

4. The method according to claim 1, wherein the pattern has a shape of a rectangle.

5. The method according to claim 4, wherein the target area is located in a center of the display panel.

6. The method according to claim 5, wherein, in the measuring of the luminance in the target area while moving the pattern, the pattern passes through the target area while moving from left of the target area to right of the target area.

7. The method according to claim 5, wherein, in the measuring of the luminance in the target area while moving the pattern, the pattern passes through the target area while moving from above the target area to below the target area.

8. The method according to claim 1, wherein the starting point of the second luminance waveform corresponds to a point prior to an adjacent point at which a reference value is measured among luminance values of the measured luminance.

9. The method according to claim 8, wherein the reference value corresponds to twice a minimum value among the luminance values of the measured luminance.

10. The method according to claim 1, wherein the ratio of the difference in area between the first luminance waveform and the second luminance waveform is calculated by dividing an absolute value of a difference between an area of the first luminance waveform and an area of the second luminance waveform by the area of the first luminance waveform.

11. A method for detecting a failure of a display device comprising a display panel comprising a plurality of pixels, the method comprising:
defining a first luminance waveform in a target area when halation does not occur;
measuring, with the display panel tilted, a luminance in the target area while moving a pattern displayed on the display panel, and drawing a second luminance waveform based on the measured luminance;
matching a starting point of the first luminance waveform and a starting point of the second luminance waveform with each other; and
calculating a ratio of a difference in area between the first luminance waveform and the second luminance waveform.

12. The method according to claim 11, wherein the first luminance waveform is defined by a speed of movement of the pattern, a width of the pattern in a direction of movement of the pattern, and a driving frequency of the display device.

13. The method according to claim 12, wherein the first luminance waveform has a pulse waveform having a width by dividing the width of the pattern by the speed of movement of the pattern, and then by the driving frequency of the display device.

14. The method according to claim 11, wherein the pattern has a shape of a rectangle, and the target area is located in a center of the display panel.

15. The method according to claim 14, wherein, in the measuring of the luminance in the target area while moving the pattern, the pattern passes through the target area while moving from left of the target area to right of the target area.

16. The method according to claim 14, wherein, in the measuring of the luminance in the target area while moving the pattern, the pattern passes through the target area while moving from above the target area to below the target area.

17. The method according to claim 11, wherein the starting point of the second luminance waveform corresponds to a point prior to an adjacent point at which a reference value is measured among luminance values of the measured luminance.

18. The method according to claim 17, wherein the reference value corresponds to twice a minimum value among the luminance values of the measured luminance.

19. The method according to claim 11, wherein the ratio of the difference in area between the first luminance waveform and the second luminance waveform is calculated by dividing an absolute value of a difference between an area of the first luminance waveform and an area of the second luminance waveform by the area of the first luminance waveform.

20. A method for detecting a failure of an electronic device comprising a display panel comprising a plurality of pixels, the method comprising:
defining a first luminance waveform in a target area when halation does not occur;
measuring, with a luminance measuring device facing a front of the display panel, a luminance in the target area while moving a pattern that is displayed on the display panel, and drawing a second luminance waveform based on the measured luminance;
matching a starting point of the first luminance waveform and a starting point of the second luminance waveform with each other; and
calculating a ratio of a difference in area between the first luminance waveform and the second luminance waveform.
